(19) United States
(12) Patent Application Publication
(10) Pub. No.: US 2024/0054513 A1
(43) Pub. Date: Feb. 15, 2024

(54) DYNAMIC STATUS MATCHING FOR PREDICTING RELATIONAL STATUS CHANGES OF GEOGRAPHIC REGIONS

(71) Applicant: Mineral Earth Sciences LLC, Mountain View, CA (US)

(72) Inventors: Hongxu Ma, Mountain View, CA (US); Grigory Bronevetsky, San Ramon, CA (US); Charlotte Leroy, Redwood City, CA (US); Yuhao Kang, Madison, WI (US)

(21) Appl. No.: 17/883,793

(22) Filed: Aug. 9, 2022

(51) Int. Cl. G06Q 30/02

(52) U.S. Cl. CPC G06Q 30/0205; G06Q 30/0201

(57) ABSTRACT

Implementations set forth herein relate to determining causal relationships between covariates and value metrics for geographic regions for training one or more machine learning models. Causal relationships between different subsets of covariates and value metrics can be determined for various durations of time and for various geographic regions. For example, a value metric may exhibit a causal relationship to certain covariates for a first geographic region during a first duration of time, but may exhibit a different causal relationship to other covariates for a second geographic region for a second duration of time. Models can be trained and utilized to predict changes in value metrics for geographic regions, thereby enabling forecasting notifications to be provided to persons who may be negatively impacted by changes to those geographic regions.

### BACKGROUND

As areas of the world develop and residents of those areas acquire real estate parcels and/or other land-related property, values for those parcels and/or property can exhibit changes that can be tracked by certain systems. Occasionally, such values can change relatively quickly, causing disruptions to the lives of residents and potentially affecting people's health and well-being. Although many tools exist for predicting such value changes to properties, these tools may only account for a single set of variables. For example, a tool that predicts changes to a property metric for a particular geographic region may only rely on a particular, static set of variables without considering changes that may have occurred for other regions because of another set of variables. As a result, trends for certain property metrics may be predicted inaccurately, thereby limiting an ability for users to estimate when a rapid disruption to their property may occur. Moreover, delaying the notifications to residents regarding such disruptions can exacerbate the repercussions of disruptions to their properties.

### SUMMARY

Implementations set forth herein relate to training and utilizing one or more machine learning models to generate causal relationship data that can be utilized to render notifications regarding changes in land, homes, parcels, and/or other land-related property. For example, one or more machine learning models can be trained by initially determining causal relationships between covariates and values for land-related property (e.g., homes, land, parcels, etc.) for different geographic regions and/or for different times. The causal relationships can be characterized by multi-dimensional vector data that can be generated using one or more different devices performing one or more processes, such as principal component analysis, neural networks, auto-encoder-decoders, and/or any other process for generating multi-dimensional vectors. For example, auto-encoder-decoders can be utilized to generate a suitable encoder for generating a vector embedding representing causal relationships between land-related covariates and land values. The auto-encoder-decoders can also be utilized to generate a suitable decoder for decoding a vector embedding and/or other embedding to determine the causal relationship(s) that may be represented by a given embedding.

When the multi-dimensional vector data (i.e., vector data) is generated for a variety of different geographic regions, a variety of different time windows, and/or a variety of different causal variable relationships, the vector data can be further processed according to one or more clustering processes. When the vector data is processed to identify a finite number of clusters within the vector data, each cluster can represent a respective type of causation status. Therefore, at any given time, in the past or present, land and/or homes within a particular geographic region can exhibit a particular type of causation status. Each causation status can classify a particular temporal relationship between the land-related covariates and a respective value metric. In some implementations, to identify such statuses, one or more clustering (i.e., grouping) methods can be utilized, including, but not limited to, K-Means, DBSCAN, actor-critic temporal phenotyping clustering (ACTPC), Toeplitz inverse covariance-based clustering (TICC), and/or any other suitable method for identifying clusters.

As an example, a set of covariates can be selected to characterize features of various geographic regions and/or times, and/or a subset of geographic regions and/or times. For each particular geographic region, a determination can be made regarding whether a causal relationship exists between each variable of the set of covariates and a value metric for property within a respective geographic region. For example, a first subset of covariates of the set of covariates can be determined to have a direct correlation to the value metric for properties in a first geographic region, a second subset of covariates of the set of covariates can be determined to have an indirect correlation to the value metric for other properties in a second geographic region, and a third subset of covariates of the set of covariates can be determined to have a direct correlation to the value metric for yet other properties in a third geographic region. In this example, a first causal status can refer to a temporal relationship between the first subset of covariates and the value metric, a second causal status can refer to another temporal relationship between the value metric and the other properties, and a third causal status can refer to yet another temporal relationship between the value metric and other properties.

Depending on the clustering process that is utilized, a cluster of vectors and/or embeddings (e.g., generated using an auto-encoder-decoder) can correspond to a particular causal status. When clusters for all the vectors have been generated and/or otherwise identified, training data characterizing how different geographic regions experience different causal statues over time can be utilized to train one or more machine learning models, such as a Recurrent Neural Network (RNN) (e.g., a Long Short Term Memory Network (LSTM)). These one or more trained machine learning models can then be utilized to generate predictive status data that may predict a causal status that a particular geographic region may exhibit in the future.

As an example, a first geographic region, such as desert property in Phoenix, Arizona, may have historically exhibited a first causal status during a first time series including the years 1980-1990, and a second causal status during a second time series including the years 1990-2010. The first causal status can correspond to an increase in a value metric for a residential structure and/or land that is correlated to changes in certain property-related covariates (e.g., a subset of covariates indicating an increase in certain mineral content and an increase in soil porosity). The second causal status can correspond to a decreasing value metric that is correlated to changes in other covariates (e.g., another subset of covariates indicating an increase in atmospheric methane and an increase in traffic accidents). A second geographic region, such as another desert property in Death Valley, California, may be exhibiting the first causal status during a third time series that includes more recent years, based on measurements taken during the recent years using one or more sensors and/or computing devices. Using this determination of causal status for the second geographic region, predictive status data can be generated to estimate whether the second geographic region will continue to exhibit the first causal status (e.g., having a value metric that changes with mineral content and soil porosity), or whether the second geographic region will transition to the second causal status (e.g., having a value metric that changes with atmospheric methane and traffic accidents).

In some implementations, predictive status data for the second geographic region can be generated by processing a set of covariates that were utilized to identify the various causal statuses. The set of covariates can be sampled from devices in, or associated with, the second geographic region during the third time series, and values for the set of covariates can be processed to determine whether the second geographic region may be transitioning to the second causal status. The variable values, and/or other input data generated from the variable values, can be processed using the one or more trained machine learning models (e.g., an LSTM). During this processing, a current causal status of the second geographic region can be considered in combination with the variable values. As a result of this processing, predictive status data generated for the second geographic region can indicate that the second geographic region may transition from exhibiting the first causal status to exhibiting the second causal status. This prediction can then be rendered at an interface of a computing device for a user that may be associated with the second geographic region, thereby allowing the user to make certain decisions regarding this predicted change in status.

The above description is provided as an overview of some implementations of the present disclosure. Further description of those implementations, and other implementations, are described in more detail below.

In some implementations, a method implemented using one or more processors may include: processing spatiotemporal data that includes land-related covariates for various geographic regions during one or more durations of time, to determine a causal relationship between one or more covariates of the land-related covariates and value metrics for the various geographic regions, wherein the one or more covariates characterize one or more respective features associated with each geographic region of the various geographic regions; generating, based on processing the spatiotemporal data, embedding data that characterizes various embeddings that can be mapped to a latent space, wherein each embedding of the various embeddings is generated to represent a determined causal relationship, between a respective subset of covariates of the land-related covariates and a value metric for a respective geographic region of the various geographic regions; determining, based on the embedding data, category data that characterizes various categories for groups of embeddings of the various embeddings, wherein each category of the various categories corresponds to a respective group of the groups of embeddings, and each category indicates a respective causal status for a subset of geographic regions of the various geographic regions; processing at least a portion of the category data, that indicates a current category of causal status for a particular geographic region of the various geographic region, and input data, that characterizes values for a subset of covariates of the land-related covariates for the particular geographic region; and causing, based on the input data and the portion of the category data, an interface of a computing device to render an indication of the value metric for the particular geographic region.

In various implementations, the indication of the value metric corresponds to an estimated value for the value metric during a particular time that is subsequent to the one or more durations of time. In various implementations, the input data characterizes the values for the subset of covariates of the land-related covariates for a separate duration of time that is subsequent to the one or more durations of time and prior to the particular time for the estimated value of the value metric.

In various implementations, the input data and the portion of the category data are processed using a long short-term memory (LSTM) model, and the indication is rendered further based on output data generated using the LSTM model. In various implementations, the method may further include generating training data for the LSTM model in furtherance of training the LSTM model based on the spatiotemporal data for the various geographic regions.

In various implementations, processing the spatiotemporal data includes selecting each respective subset of covariates for each embedding using principal component analysis (PCA) of the one or more covariates of the land-related covariates and the value metrics for the various geographic regions. In various implementations, processing the spatiotemporal data includes selecting each respective subset of covariates for each embedding based on generating an auto-encoder-decoder from the one or more covariates of the land-related covariates and the value metrics for the various geographic regions and for various time windows.

In a related aspect, a method implemented by one or more processors may include: processing, by a computing device, input data that characterizes values for a set of land-related covariates for a particular geographic region for a duration of time, wherein the land-related covariates characterize a value metric for the particular geographic region and features of the particular geographic region; determining, based on processing the input data, a first causal status that indicates a temporal relationship between the features of the particular geographic region and the value metric for the particular geographic region; processing, by the computing device, additional input data that indicates the first causal status for the particular geographic region and characterizes other values for the set of land-related covariates for the particular geographic region for another duration of time; and generating, based on processing the additional input data, predictive status data that indicates a second causal status for the particular geographic region for a forthcoming duration of time, wherein the predicted status data is generated further based on a separate geographic region transitioning, over time, between exhibiting the first causal status and the second causal status; and causing, based on the predictive status data, an interface that communicates with the computing device or another computing device to render an indication of the second causal status for the particular geographic region.

In various implementations, the additional input data is processed using a LSTM model, and the indication is rendered further based on output data generated using the LSTM model. In various implementations, the particular geographic region includes residential structures and one or more of the features characterized by the land-related covariates are based on the residential structures.

In various implementations, the second causal status is based on a subset of covariates of the land-related covariates that is different than another subset of covariates of the land-related covariates on which the first causal status is based. In various implementations, the subset of covariates and the other subset of covariates are selected using principal component analysis (PCA) of the land-related covariates and the value metrics for the various geographic regions. In various implementations, the subset of covariates and the other subset of covariates are selected based on generating an auto-encoder-decoder from the land-related covariates and the value metrics for the various geographic regions.

Other implementations may include a non-transitory computer readable storage medium storing instructions executable by one or more processors (e.g., central processing unit(s) (CPU(s)), graphics processing unit(s) (GPU(s)), and/or tensor processing unit(s) (TPU(s)) to perform a method such as one or more of the methods described above and/or elsewhere herein. Yet other implementations may include a system of one or more computers that include one or more processors operable to execute stored instructions to perform a method such as one or more of the methods described above and/or elsewhere herein.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1A, FIG. 1B, and FIG. 1C illustrate views of a system that operates to determine causal relationships between covariates and values for geographic regions, and utilizes the causal relationships to predict future changes to those values.

FIG. 2 illustrates a method for generating data that can be utilized to render notifications regarding changes in causal statuses of land, homes, parcels, and/or other land-related property.

FIG. 3 is a block diagram of an example computer system.

### DETAILED DESCRIPTION

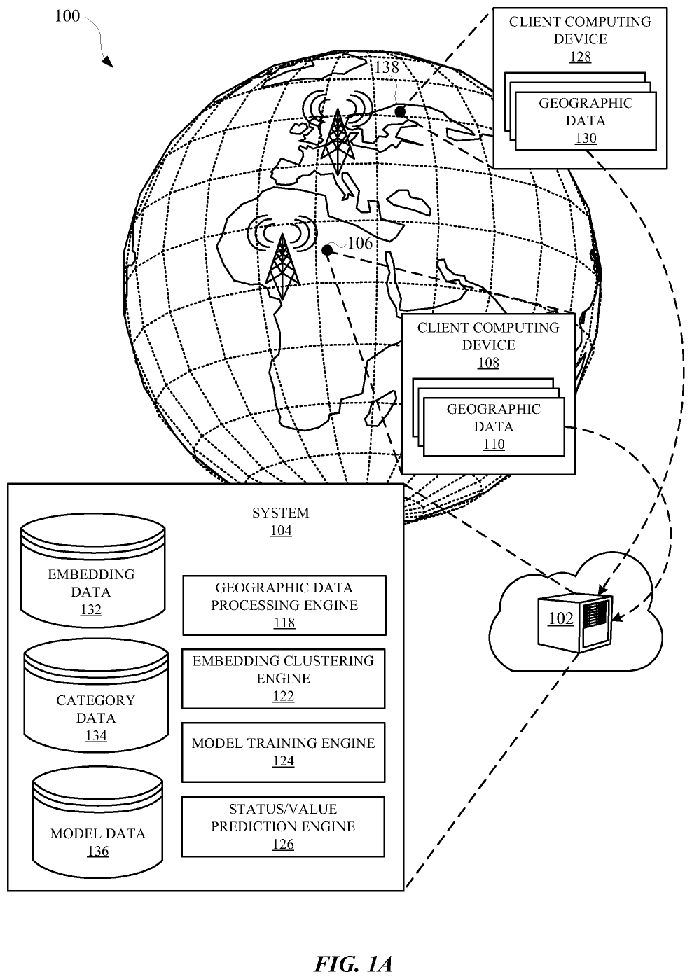

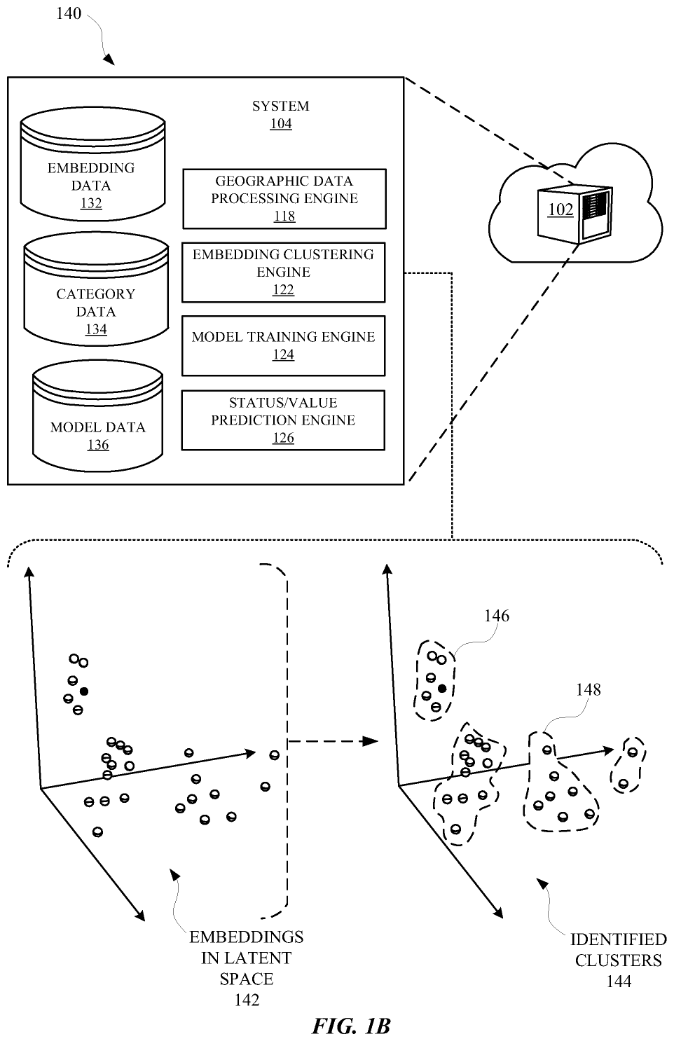

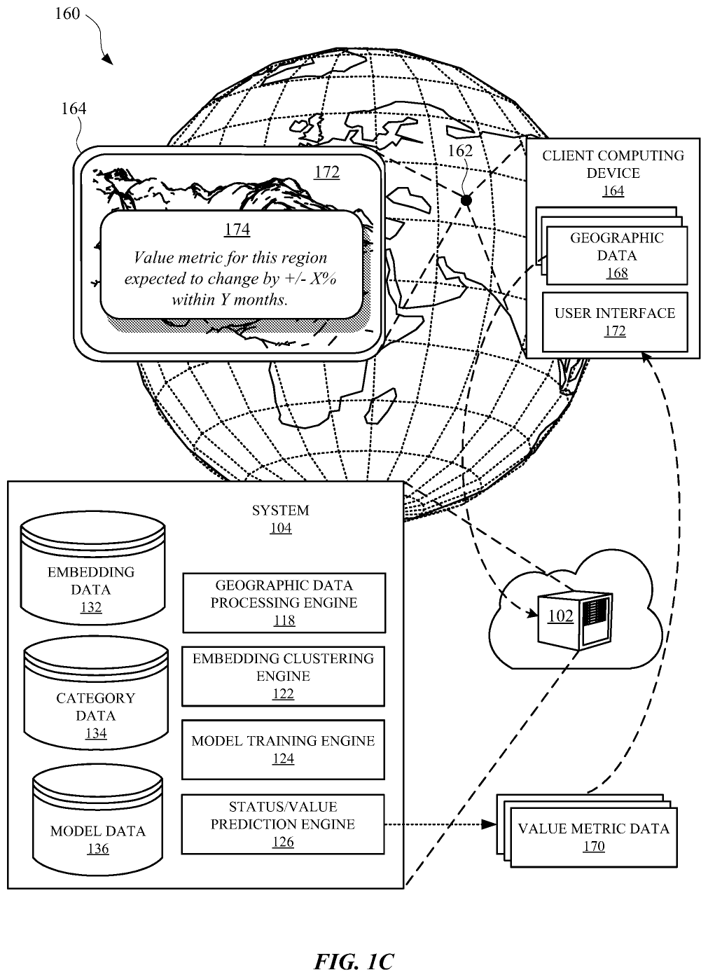

FIG. 1A, FIG. 1B, and FIG. 1C illustrate a view 100, a view 140, and a view 160 of a system 104 that operates to determine causal relationships between covariates and values for geographic regions, and utilizing the causal relationships to predict future changes to geographic regions. A causal status can indicate how a subset of covariates trends with a value metric over time, and how different geographic regions can exhibit different causal statuses at different times. For example, one or more client computing devices (e.g., a client computing device 108 and a client computing device 128) can provide spatiotemporal data (e.g., spatiotemporal data 110 and spatiotemporal data 130) that can be processed by the system 104. The spatiotemporal data 110 and the spatiotemporal data 130 can characterize values for covariates, which can include any land-related variables and/or any property related variables. The spatiotemporal data 110 can include covariate values for a first geographic region, and the spatiotemporal data 130 can include covariate values for a second geographic region. In some implementations, the types of covariates that are identified for processing can be the same or different for various geographic regions.

Each client computing device can include one or more sensors and/or otherwise have access to information from which to determine the values for the covariates to be processed. For example, the client computing devices can be in communication with soil sensors, weather sensors, traffic sensors, and/or any other types of sensors that users may desire to utilize to generate the spatiotemporal data for each respective geographic region and/or each respective temporal window of time. The spatiotemporal data can be communicated to a server computing device 102 and/or other device for processing by the system 104. The system 104 can comprise one or more devices, applications, and/or other modules for processing input data and/or generating output data. For example, the system 104 can include a spatiotemporal data processing engine 118 for processing the spatiotemporal data for the geographic regions and generating embeddings from the spatiotemporal data. The embeddings can correspond to multi-dimensional vectors and/or other information mappings that can represent a determined relationship between certain covariates and value metrics for various geographic regions. Said another way, each embedding can represent a causal relationship between a subset of covariates and a value metric for a particular duration of time for a respective geographic region.

Each embedding can be generated according to one or more processes, such as principal component analysis, fully connected neural networks, auto-encoder-decoder structures, and/or any other process for generating representations of data. For example, an embedding representing a first geographic region 106 during a first duration of time can be generated using an auto-encoder-decoder structure, and another embedding representing a second geographic region 138 during a second duration of time can be generated using a different auto-encoder-decoder structure. Embeddings for multiple different durations of time for the same geographic regions and for different geographic regions can be generated to represent causal statuses of the geographic regions for different durations of time. For example, the first geographic region 106 can exhibit a first causal relationship between a first subset of covariates and a value metric for the years 1960-1975. The first geographic region 106 can also exhibit a second causal relationship between a second subset of covariates and the value metric for a time series that includes the years 1980-1994. Additionally, the second geographic region 138 can exhibit a third causal relationship between a third subset of covariates and a value metric for another time series that includes the years 1960-1975. The second geographic region 138 can also exhibit a fourth causal relationship between the fourth subset of covariates and the value metric for the time series that includes the years 1980-1994. In some implementations, each of the subsets of covariates can include one or more of the same covariates and/or one or more different covariates.

In some implementations, the spatiotemporal data processing engine 118 can generate embedding data for mapping the embeddings in latent space 142, as illustrated in FIG. 1B. When the embeddings have been generated, an embedding clustering engine 122 can utilize one or more processes for identifying clusters of embeddings in the latent space 142. Identified clusters 144 can then be utilized to determine category data 134 for identifying categories for causal relationships between subsets of covariates and value metrics. In some implementations, the one or more processes for identifying clusters of embeddings can include grouping methods such as K-Means, DBSCAN, ACTPC, TICC, and/or any other grouping method that can be utilized to identify groupings of embeddings. For example, a first cluster 146 of embeddings and a second cluster of embeddings can be identified using any suitable grouping method or other process for identifying clusters. Each cluster can correspond to a particular category of causal status that various geographic regions may or may not exhibit from time to time. For example, the first geographic region 106 can exhibit the first causal relationship, which can correspond to the first cluster 146, and the second geographic region 138 can exhibit the second causal relationship, which can correspond to the second cluster 148.

Although exhibiting a particular causal status relationship may not result in a negative trend in value metrics for a region, an indication that a particular region is starting to exhibit features of a different causal status relationship may indicate a negative trend in value metrics for the region. For example, spatiotemporal data and status data can indicate that a particular geographic region currently has a first causal relationship status and may be trending towards exhibiting a second causal relationship status. This may negatively impact the particular geographic region because a set of covariates corresponding to the second causal relationship may be trending in a way that will cause a negative trend for a value metric for the particular geographic region. Therefore, predicting the change or transition to another causal status relationship can assist with predicting changes to value metrics for particular regions.

For example, embedding data 132, category data 134, and/or spatiotemporal data 110 can be utilized by a modeling training engine 124 to generate model data 136 characterizing one or more one or more trained machine learning models. The one or more models can include, but are not limited to, a deep neural network model (e.g., an LSTM) and/or another type of machine learning model. The one or more trained machine learning models can then be utilized for processing other spatiotemporal data to predict a value metric for a corresponding geographic region and/or predict a change in causal status for the geographic region. For example, a client computing device 164 corresponding to a third geographic region 162 can provide spatiotemporal data 168 to the system 104 for processing using the model data 136. When processing the spatiotemporal data 168 and/or a current causal status of the third geographic region 162 using one or more trained models, a causal status for the third geographic region 162 for a subsequent duration of time can be estimated. Alternatively, or additionally, processing the spatiotemporal data 168 and/or the current causal status of the third geographic region 162 using the one or more trained models can be performed to estimate value metric data 170 and/or a change in a value metric for the third geographic region 162.

In some implementations, the value metric data 170 can be processed to generate a notification 174 to be rendered at an interface 172 of the client computing device 164 and/or another computing device that can be associated with the third geographic region 162. For example, when an estimated value metric for the third geographic region 162 is predicted to change by a threshold amount (e.g., a percentage amount), and optionally within a threshold duration of time, the system 104 can cause a computing device to render a notification 174. In some implementations, the notification 174 can indicate a degree to which the value metric is expected to change for a particular region, the set of covariates that were utilized to make the change prediction, and/or an estimated amount of time until the change to the value metric is predicted to occur.

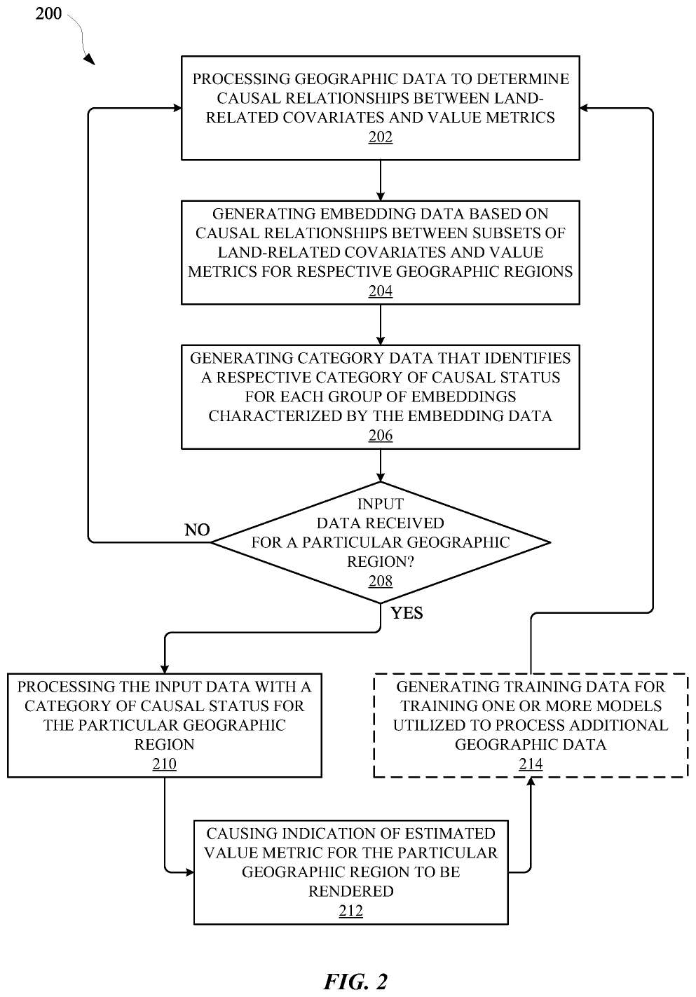

FIG. 2 illustrates a method 200 for generating and processing data that can be utilized to render notifications regarding changes in causal statuses of land, homes, parcels, and/or other land-related property. The method 200 can be performed by one or more computing devices, applications, and/or any other apparatus or module that can be associated with an automated assistant. The method 200 can include an operation 202 of processing spatiotemporal data to determine causal relationships between land-related covariates and value metrics. The land-related covariates and the value metrics can be determined for a variety of different geographic regions for a variety of different durations of time. For example, the spatiotemporal data can be captured for multiple different cities on the same or different continents, countries, etc., and for different durations of time such as between any one or more decades, years, months, days, etc. The land-related covariates for any geographic region and/or duration of time can include, but are not limited to: a number of bedrooms in a house in a geographic region, a number of bathrooms in a house in the geographic region, a type of room on a house in the geographic region, characteristic(s) of soil in the geographic region, characteristic(s) of climate in the geographic region, characteristic(s) of traffic in the geographic region, characteristic(s) of vegetation in the geographic region, characteristic(s) of air quality in the geographic region, and/or any other characteristics that can be determined for a geographic region.

In some implementations, causal relationships between one or more covariates and value metrics for various geographic regions can be determined using a variety of different processes. For example, principal component analysis (PCA), neural networks, and/or auto-encoder-decoders can be utilized to identify causal relationships between covariates and value metrics for geographic regions. PCA can be utilized to generate lower dimensional data (e.g., vector data) representing a relationship between a subset of covariates and a value metric for a geographic region during a duration of time. For example, vector data generated using PCA can characterize a relationship between climate characteristics and land value for a first geographic region, and other vector data generated using PCA can characterize another relationship between traffic characteristics and land value for a second particular region.

The method 200 can proceed from the operation 202 to an operation 204 that can include generating embedding data based on the causal relationships between subsets of land-related covariates and value metrics for respective geographic regions. The embeddings can correspond to vector data that is mapped to a latent space to create mappings of various embeddings in the latent space. Each embedding in the latent space can correspond to a particular geographic region for a particular duration of time, and can indicate a causal status of the particular geographic region during that particular duration of time. A particular causal status can refer to a relationship between a particular subset of covariates and a value metric, exhibited by a particular geographic region during a particular duration of time. For example, a first embedding can be mapped to represent the first geographic region exhibiting a correlation between positive climate characteristics and rising land value between 1960 and 1970. As another example, a second embedding can be mapped to represent the second geographic region exhibiting a correlation between increasing traffic and decreasing land value between 1980 and 1990. The latent space can therefore include the first embedding and the second embedding, and any other embeddings that are generated from the spatiotemporal data.

The method 200 can proceed from the operation 204 to an operation 206, which can include generating category data that identifies a respective category of causal status for each group of embeddings of the embeddings characterized by the embedding data. Identifying categories of causal status can be performed using one or more processes such as K-Means, K-Median, Agglomerative, Divisive, DBSCAN, ACTPC, TICC, and/or any other process for identifying clusters of embeddings and/or clusters of other data representations. For example, TICC can be utilized to create a time-varying network of clusters that can be categorized. Alternatively, or additionally, DBSCAN can be utilized to identify distances between embeddings in latent space for creating arbitrary-shaped clusters. When clusters are identified, each cluster can be given an arbitrary or non-arbitrary category label to indicate a category of causal status for geographic regions that may exhibit such causal status during a duration of time. The category data can then be utilized to train a neural network (e.g., a deep neural network) such as, but not limited to, an LSTM model. In some implementations, a current causal status of a particular geographic region can be fed into the trained LSTM with current values for the covariates to predict any change to the current causal status for the particular geographic region.

The method 200 can proceed from the operation 206 to an operation 208 of determining whether input data has been received for a particular geographic region. When input data is determined to have been received, the method can proceed from the operation 208 to an operation 210. Otherwise, the method 200 can optionally return to the operation 202 for processing spatiotemporal data in furtherance of refining the category data and/or training one or more machine learning models. The input data can include values for covariates for a particular geographic region during a prior duration of time and/or a current time, and/or for estimated values of covariates for the particular geographic region during a future time. In some implementations, the input data can also identify a current category of causal status for the particular geographic region. In this way, the current category of causal status can be processed with the current value for the covariates, or a subset of the covariates, to predict a change to the current causal status for the particular geographic region.

The method 200 can proceed from the operation 208 to the operation 210, which can include processing the input data with a current category of causal status for the particular geographic region to determine an estimate for a subsequent category of causal status for the particular geographic region. In some implementations, the input data can be processed using an LSTM, which can be utilized to generate output data that can indicate a particular estimated category of causal status for the particular geographic region. The estimated causal status can indicate, relative to the current causal status for the particular geographic region, whether the value metric for the particular geographic region will increase, decrease, or stay the same. In some implementations, the estimated causal status can be utilized to indicate an estimated value metric for the particular geographic region for a future time period. For example, when the particular geographic region is predicted to transition into a particular causal status, values can be identified for a particular subset of covariates that have been determined to most correlate with the estimated value metric per that particular causal status. Those values can be utilized to project a subsequent value for the value metric, based on a current value for the value metric and the values for the particular subset of covariates.

The method 200 can proceed from the operation 210 to an operation 212 of causing an indication of the estimated value metric for the particular geographic region to be rendered at an interface of a computing device. In some implementations, the indication that is rendered can convey the estimated causal status for the particular geographic region. Alternatively, or additionally, the indication that is rendered can convey a predicted change in the estimated causal status and/or value metric for the particular geographic region. In this way, changes that may affect people's health, safety, and/or property can be rendered for people associated with the particular geographic region that may be affected by such changes. The method 200 can optionally proceed from the operation 212 to an optional operation 214 of generating training data for training one or more models utilized to process additional spatiotemporal data. In this way, the one or more models can be further adapted to provide more accurate results and make more accurate predictions over time as additional spatiotemporal data is generated for various geographic regions.

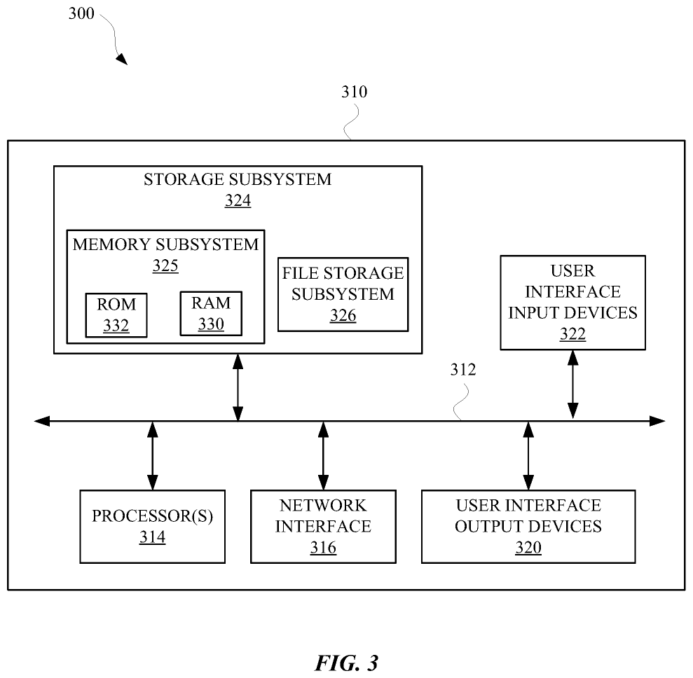

FIG. 3 is a block diagram 300 of an example computer system 310. Computer system 310 typically includes at least one processor 314 which communicates with a number of peripheral devices via bus subsystem 312. These peripheral devices may include a storage subsystem 324, including, for example, a memory 325 and a file storage subsystem 326, user interface output devices 320, user interface input devices 322, and a network interface subsystem 316. The input and output devices allow user interaction with computer system 310. Network interface subsystem 316 provides an interface to outside networks and is coupled to corresponding interface devices in other computer systems.

User interface input devices 322 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computer system 310 or onto a communication network.

User interface output devices 320 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computer system 310 to the user or to another machine or computer system.

Storage subsystem 324 stores programming and data constructs that provide the functionality of some or all of the modules described herein. For example, the storage subsystem 324 may include the logic to perform selected aspects of method 200, and/or to implement one or more of system 104, client computing devices, and/or any other application, device, apparatus, and/or module discussed herein.

These software modules are generally executed by processor 314 alone or in combination with other processors. Memory 325 used in the storage subsystem 324 can include a number of memories including a main random access memory (RAM) 330 for storage of instructions and data during program execution and a read only memory (ROM) 332 in which fixed instructions are stored. A file storage subsystem 326 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 326 in the storage subsystem 324, or in other machines accessible by the processor(s) 314.

Bus subsystem 312 provides a mechanism for letting the various components and subsystems of computer system 310 communicate with each other as intended. Although bus subsystem 312 is shown schematically as a single bus, alternative implementations of the bus subsystem may use multiple busses.

Computer system 310 can be of varying types including a workstation, server, computing cluster, blade server, server farm, or any other data processing system or computing device. Due to the ever-changing nature of computers and networks, the description of computer system 310 depicted in FIG. 3 is intended only as a specific example for purposes of illustrating some implementations. Many other configurations of computer system 310 are possible having more or fewer components than the computer system depicted in FIG. 3.

In situations in which the systems described herein collect personal information about users (or as often referred to herein, “participants”), or may make use of personal information, the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

We claim:

1. A method implemented by one or more processors, the method comprising:
processing spatiotemporal data that includes land-related covariates for various geographic regions during one or more durations of time, to determine a causal relationship between one or more covariates of the land-related covariates and value metrics for the various geographic regions,
wherein the one or more covariates characterize one or more respective features associated with each geographic region of the various geographic regions;
generating, based on processing the spatiotemporal data, embedding data that characterizes various embeddings that can be mapped to a latent space,
wherein each embedding of the various embeddings is generated to represent a determined causal relationship, between a respective subset of covariates of the land-related covariates and a value metric for a respective geographic region of the various geographic regions during a respective time;
determining, based on the embedding data, category data that characterizes various categories for groups of embeddings of the various embeddings,
wherein each category of the various categories corresponds to a respective group of the groups of embeddings, and each category indicates a respective causal status for a subset of geographic regions of the various geographic regions during different times;
processing at least a portion of the category data, that indicates a current category of causal status for a particular geographic region of the various geographic region, and input data, that characterizes values for a subset of covariates of the land-related covariates for the particular geographic region; and
causing, based on the input data and the portion of the category data, an interface of a computing device to render an indication of the value metric for the particular geographic region for a particular time.

2. The method of claim 1, wherein the indication of the value metric corresponds to an estimated value for the value metric during the particular time that is subsequent to the one or more durations of time.

3. The method of claim 2, wherein the input data characterizes the values for the subset of covariates of the land-related covariates for a separate duration of time that is subsequent to the one or more durations of time and prior to the particular time for the estimated value of the value metric.

4. The method of claim 1, wherein the input data and the portion of the category data are processed using a long short-term memory (LSTM) model, and the indication is rendered further based on output data generated using the LSTM model.

5. The method of claim 4, further comprising:
generating training data for the LSTM model in furtherance of training the LSTM model based on the spatiotemporal data for the various geographic regions.

6. The method of claim 1, wherein processing the spatiotemporal data includes:
selecting each respective subset of covariates for each embedding using principal component analysis (PCA) of the one or more covariates of the land-related covariates and the value metrics for the various geographic regions.

7. The method of claim 1, wherein processing the spatiotemporal data includes:
selecting each respective subset of covariates for each embedding based on generating an auto-encoder-decoder from the one or more covariates of the land-related covariates and the value metrics for the various geographic regions.

8. A method implemented by one or more processors, the method comprising:
processing, by a computing device, input data that characterizes values for a set of land-related covariates for a particular geographic region for a duration of time,
wherein the land-related covariates characterize a value metric for the particular geographic region and features of the particular geographic region;
determining, based on processing the input data, a first causal status that indicates a temporal relationship between the features of the particular geographic region and the value metric for the particular geographic region;
processing, by the computing device, additional input data that indicates the first causal status for the particular geographic region and characterizes other values for the set of land-related covariates for the particular geographic region for another duration of time; and
generating, based on processing the additional input data, predictive status data that indicates a second causal status for the particular geographic region for a forthcoming duration of time,
wherein the predicted status data is generated further based on a separate geographic region transitioning, over time, between exhibiting the first causal status and the second causal status; and
causing, based on the predictive status data, an interface that communicates with the computing device or another computing device to render an indication of the second causal status for the particular geographic region.

9. The method of claim 8, wherein the additional input data is processed using a long short-term memory (LSTM) model, and the indication is rendered further based on output data generated using the LSTM model.

10. The method of claim 8, wherein the particular geographic region includes residential structures and one or more of the features characterized by the land-related covariates are based on the residential structures.

11. The method of claim 8, wherein the second causal status is based on a subset of covariates of the land-related covariates that is different than another subset of covariates of the land-related covariates on which the first causal status is based.

12. The method of claim 11, wherein the subset of covariates and the other subset of covariates are selected using principal component analysis (PCA) of the land-related covariates and the value metrics for the various geographic regions.

13. The method of claim 11, wherein the subset of covariates and the other subset of covariates are selected based on generating an auto-encoder-decoder from the land-related covariates and the value metrics for the various geographic regions.

14. A system, comprising:
one or more processors, and
memory storing instructions that, when executed by the one or more processors, cause the one or more processors to perform operations that include:
processing spatiotemporal data that includes land-related covariates for various geographic regions during one or more durations of time, to determine a causal relationship between one or more covariates of the land-related covariates and value metrics for the various geographic regions,
wherein the one or more covariates characterize one or more respective features associated with each geographic region of the various geographic regions;
generating, based on processing the spatiotemporal data, embedding data that characterizes various embeddings that can be mapped to a latent space,
wherein each embedding of the various embeddings is generated to represent a determined causal relationship, between a respective subset of covariates of the land-related covariates and a value metric for a respective geographic region of the various geographic regions for a respective time;
determining, based on the embedding data, category data that characterizes various categories for groups of embeddings of the various embeddings,
wherein each category of the various categories corresponds to a respective group of the groups of embeddings, and each category indicates a respective causal status for a subset of geographic regions of the various geographic regions at different times;
processing at least a portion of the category data, that indicates a current category of causal status for a particular geographic region of the various geographic region, and input data, that characterizes values for a subset of covariates of the land-related covariates for the particular geographic region; and
causing, based on the input data and the portion of the category data, an interface of a computing device to render an indication of the value metric for the particular geographic region for a particular time.

15. The system of claim 14, wherein the indication of the value metric corresponds to an estimated value for the value metric during the particular time that is subsequent to the one or more durations of time.

16. The system of claim 15, wherein the input data characterizes the values for the subset of covariates of the land-related covariates for a separate duration of time that is subsequent to the one or more durations of time and prior to the particular time for the estimated value of the value metric.

17. The system of claim 14, wherein the input data and the portion of the category data are processed using a long short-term memory (LSTM) model, and the indication is rendered further based on output data generated using the LSTM model.

18. The system of claim 17, wherein the operations further include:
generating training data for the LSTM model in furtherance of training the LSTM model based on the spatiotemporal data for the various geographic regions.

19. The system of claim 14, wherein processing the spatiotemporal data includes:
selecting each respective subset of covariates for each embedding using principal component analysis (PCA) of the one or more covariates of the land-related covariates and the value metrics for the various geographic regions.

20. The system of claim 14, wherein processing the spatiotemporal data includes:
selecting each respective subset of covariates for each embedding based on generating an auto-encoder-decoder from the one or more covariates of the land-related covariates and the value metrics for the various geographic regions.
